(19) United States
(12) Patent Application Publication
(10) Pub. No.: US 2018/0114392 A1
(43) Pub. Date: Apr. 26, 2018

(54) Voter-driven legislation balancing system for supporting deliberative democracy

(71) Applicant: Voter Capital Inc., Woodside, CA (US)

(72) Inventor: Luis R. Mejia, Woodside, CA (US)

(21) Appl. No.: 15/789,925

(22) Filed: Oct. 20, 2017

Related U.S. Application Data
(60) Provisional application No. 62/410,962, filed on Oct. 21, 2016.

(51) Int. Cl. G07C 13/00; G06Q 50/26

(52) U.S. Cl. CPC G07C 13/00; G06Q 2230/00; G06Q 50/26

(57) ABSTRACT

A voter-driven system for supporting deliberative democracy reports legislative bills to voters, allows interaction among the voters to share and find common interests and create voter movements, disseminates voter movements and/or influencing action information to the voters, and aggregates the voter movements and/or influencing actions in a district aggregation database and/or a national database. The system communicates to legislators information about voter movements and/or influencing actions and provides the voters and/or voter movements with information of actions by legislators and the effect of the voter influencing tools on the actions. The system may include a snap voting system and may provide the voters with rewards for voter participation in voter movements and/or influencing actions. The system may provide a scorecard reporting a legislator's voting record relative to a voter's interests and influencing actions. The system may also allow voters to initiate and modify a legislative initiative and monitor a legislator's response to the initiative.

### CROSS-REFERENCE TO RELATED APPLICATIONS

This application claims priority from U.S. Provisional Patent Application 62/410962 filed Oct. 21, 2016, which is incorporated herein by reference.

### FIELD OF THE INVENTION

The present invention relates generally to systems and methods for supporting legislative and political activity. More specifically, it relates to systems and methods that enhance education and influence of voters in legislative and political processes.

### BACKGROUND OF THE INVENTION

Legislators respond to signals that shape their voting on bills and related legislative actions. Legislative currency is votes for an elected official to gain and retain office. Money is an important ingredient in election campaigns to win votes. Campaign contributions provide candidates and office holders with necessary capital for seeking and retaining their elected position. Money from interest groups creates influence with legislators. The goal is to counter this influence by providing balancing incentives for legislators to affect their behavior to reflect a voter group's interest. The result is voter capital.

### BRIEF SUMMARY OF THE INVENTION

In one aspect, the invention provides a voter-driven system for supporting deliberative democracy in the form of a voter-to-voters-to-legislator platform. The system includes a legislative bill reporting module configured to report legislative bills to voters via a user interface from a bills database. It includes a voter interaction module configured to allow interaction via a user interface among voters to share and find common interests, to create voter movements, including legislative movements, of voters having common interests, to disseminate voter movements and/or influencing action information to the voters, and to aggregate the voter movements and/or influencing actions around political issues in a district aggregation database and/or a national database. The system includes a legislator influencing module configured to communicate to legislators information about voter movements and/or influencing actions using influencing tools, where voter movements may be assigned weighting power based on the number of voters in the movements and the influencing modalities used. The system includes a legislator feedback module configured to provide the voters and/or voter movements with information via a user interface of actions by legislators and the effect of the voter influencing tools on the actions.

The voter-driven system influencing tools may include a snap voting system for collecting snap votes from the voters and to convey snap vote results to legislators. The voter-driven system may include a reward module configured to provide the voters with rewards for voter participation in voter movements and/or influencing actions.

The voter-driven system legislator feedback module may be configured to provide a scorecard displaying tabulated scores reflecting a legislator's voting record, retrieved from a legislator database and from a bills database, in relation to a voter's interests. The voter-driven system legislator influencing module may be configured to communicate with an activist representing the interest of a voter movement, and/or may be configured to facilitate decisions in district election voting for a district and communicate the results to legislators representing the district.

In another aspect, the invention provides a voter-driven method for supporting deliberative democracy. The method includes presenting a legislative initiative to voters using an electronic communications network, creating a voter movement on the legislative initiative; conducting a snap-vote among voters belonging to the voter movement; dynamically scoring the snap-vote using logic in a computing device; communicating the result to a legislator; and alerting the voters belonging to the voter movement of a legislator response to a snap-vote. Optionally, the method may include updating a user interface with snap-vote results, and/or assigning a score to a scorecard based on a reaction of the legislator to snap-votes, and graphically displaying the scorecard.

In another aspect, the invention provides a voter-to-voter legislation generator method including initiating a legislative initiative by one or more voters; modifying the legislative initiative by the voters over a communication system; communicating the modified legislative initiative to legislators; monitoring responses by the legislators to the modified legislative initiative; and alerting the voters of activity on the modified legislative initiative. Optionally, the method may include displaying the responses by the legislators to the modified legislative initiative.

In another aspect, the invention provides a method for rewarding voter participation including creating action points; awarding action points to a voter for participation in a movement; converting the action points into an alternative currency or coupon; and recording the converted action points in an electronic format in a computing storage device. Optionally, the method may include redeeming the alternative currency or coupon, recording action points in a block chain format, and/or recording action points in an open ledger.

### BRIEF DESCRIPTION OF THE SEVERAL VIEWS OF THE DRAWINGS

FIG. 1 is an illustration of voter driven legislation balancing system, according to an embodiment of the invention.

FIG. 2 is a representation of voters networking and spawning initial issue group movements through the V2V network that form the foundation of viral movements, according to an embodiment of the invention.

FIG. 3 is an illustration of voter influencing actions, according to an embodiment of the invention.

FIG. 4 is an illustration of a voter influence and leveling system, according to an embodiment of the invention.

FIG. 5 is a representation of a Scorecard User Interface, according to an embodiment of the invention.

FIG. 6 is an illustration of V2V Snap Voting system, according to an embodiment of the invention.

FIG. 7 is an illustration of V2V legislation proposal system, according to an embodiment of the invention.

FIG. 8 is an illustration of a voter-influencer reinforcement system, according to an embodiment of the invention.

FIG. 9 is a block diagram of a voter-driven system for supporting deliberative democracy, according to an embodiment of the invention.

### DETAILED DESCRIPTION OF THE INVENTION

A voter-voters-to-legislator (V²2L) platform disrupts legislative imbalances and spurs authentic deliberation in lawmaking by motivating voters to organize around common interests and contribute to and collaborate on legislation.

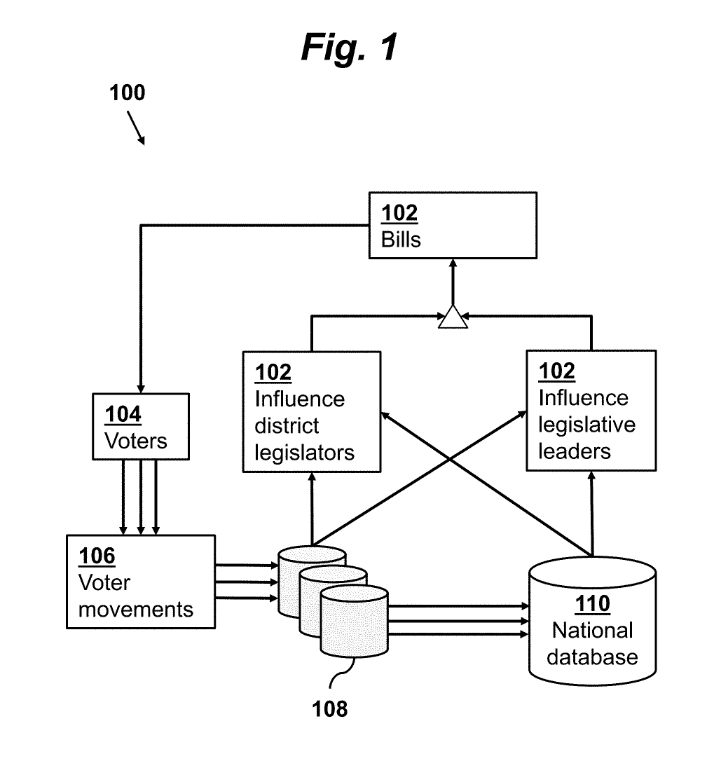

Referring to FIG. 1, shown is an overview of a V²2L platform 100 implemented on a computer network to aggregate voters into interest groups and provide the tools for them to take action on legislation that affects the voting group's interest. Bills 102 in the US Congress, State legislatures, or local governments are generated on any topic, for instance education, health care, labor, etc. Even before a particular bill is introduced, the subject of the bill may be a political topic that is working its way into the legislative process. The existence of a bill or legislative initiative is reported to Voters 104 via the V²2L platform's 100 user interface to inform them of the proposed or pending legislation to create an awareness of the issues allowing a voter group to network and to form a Voter Movement 106. Voter Movements, which may include legislative movements, are organized at multiple governmental levels, national, state, congressional districts, state legislative districts and local governments. Data on legislation, legislators, influencing actions and Voter Movements are aggregated both at the governmental level and around issues in the District Aggregation Database 108. The aggregated District Data 108 is entered into and maintained in a National Database or bases 110. The data collected are used to motivate legislators to respond to the Voter Movements 106 as Voters 104 and/or Voter Movements interact among themselves and with legislators on legislation via the V²2L platform 100. Voter Movements in a legislator's district have impact as voters in the next election, and voters outside of the district can impact the legislator by financial support for actions on selected legislation that the legislator is proposing or on which he/she votes.

Still referring to FIG. 1, the V²2L platform 100 provides a feedback mechanism to provide Voter Movements 106 with knowledge of Legislators' actions. Voter Movements 106 can respond to such Legislators' actions with further strategic influencing actions to further attempt to modify their Legislators' behavior. This feedback loop can continue through a plurality of iterations with the ultimate objective of obtaining deliberative democracy in the legislative process. Deliberative democracy maintains that in order for a legislative process to be legitimate, it must be preceded by authentic deliberation, that is, deliberation by elected officials that is free from the imbalances of unequal legislative power, such as the power a legislator obtains from the influence of wealthy individuals and/or special interests.

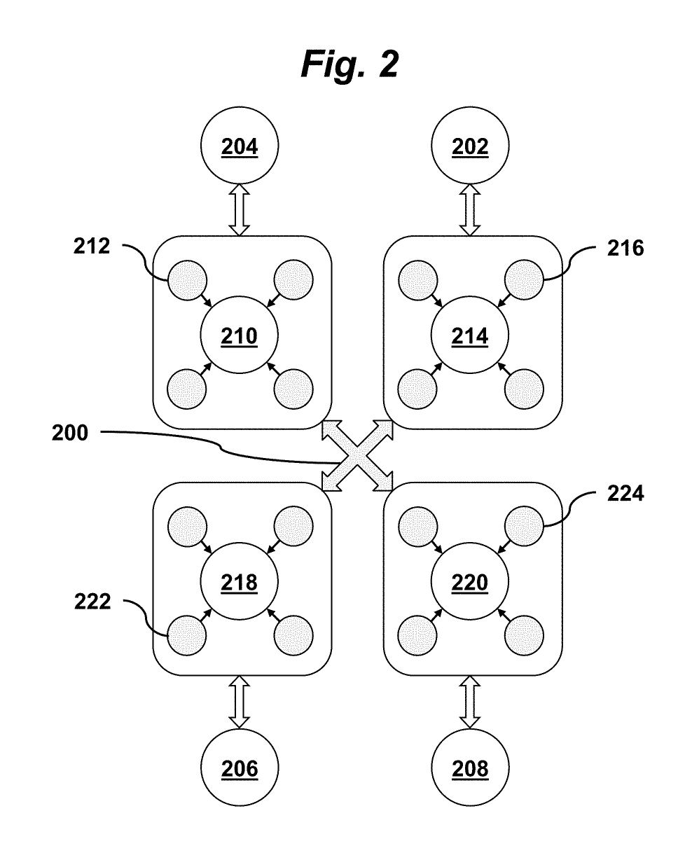

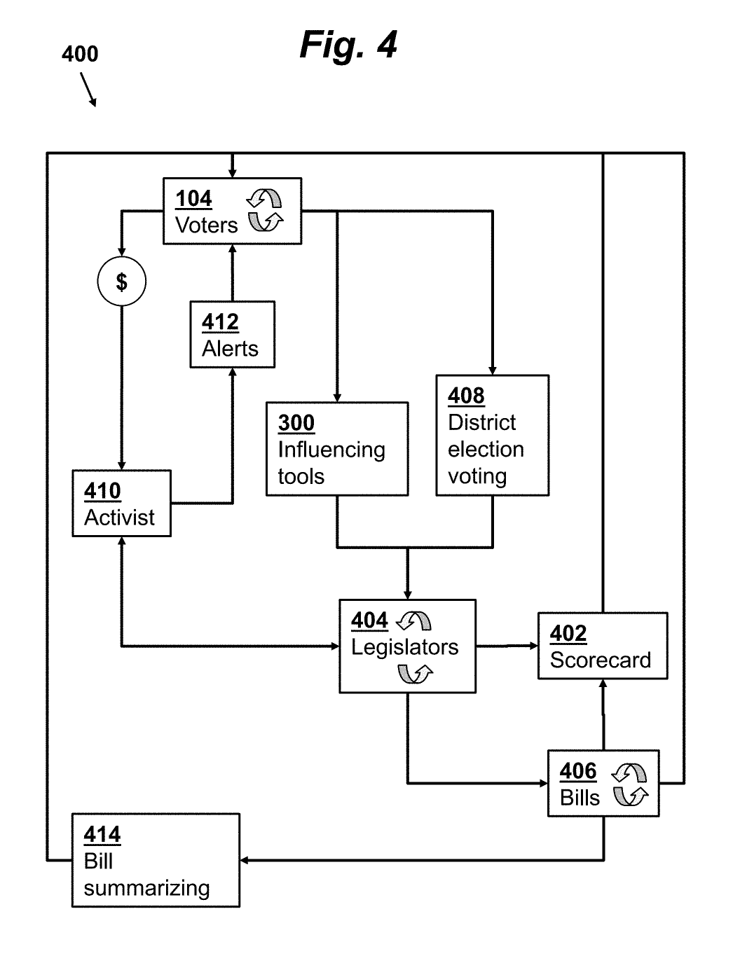

Referring to FIG. 2, shown is a representation of the Voter-2-Voter (“V2V”) networking and viral mechanism of voter movements. V2V networking 200 is represented at the intersection of voters 202, 204, 206, 208, and their influencing actions 212, 216, 222, 224 on legislators 210, 214, 218, 220, respectively. As an example, Voter 202 may be interested in an issue like student loans, Voter 204 may be interested in a specific congressional district election, Voter 206 may be interested in a specific piece of legislation, and Voter 208 may be interested in process reform, etc. The intersection at 200 allows for voters to share and find common interests. When two or more voters find a common interest, they can then create a Movement that can be virally disseminated through the V2V network and to their own personal networks, thus employing the network effect to enhance the influencing power of the V²2L platform. The shorthand descriptor, V²2L, represents the power of voters (i.e., V², via the network effect) and the 2L, the connection of the voter movements to legislators. Voter capital, the effect on legislation, is amplified in impact by the viral nature of V2V movements and concomitant influencing power attained through the feedback mechanisms of the voter capital system as subsequently represented in FIG. 4 and its related disclosure.

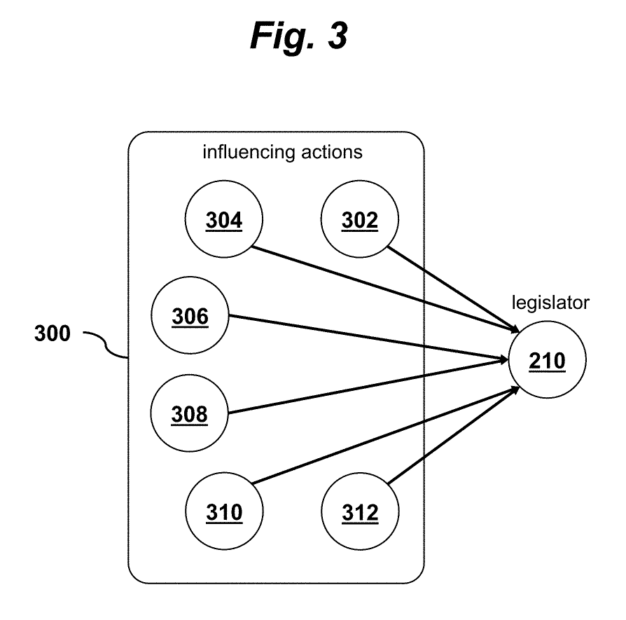

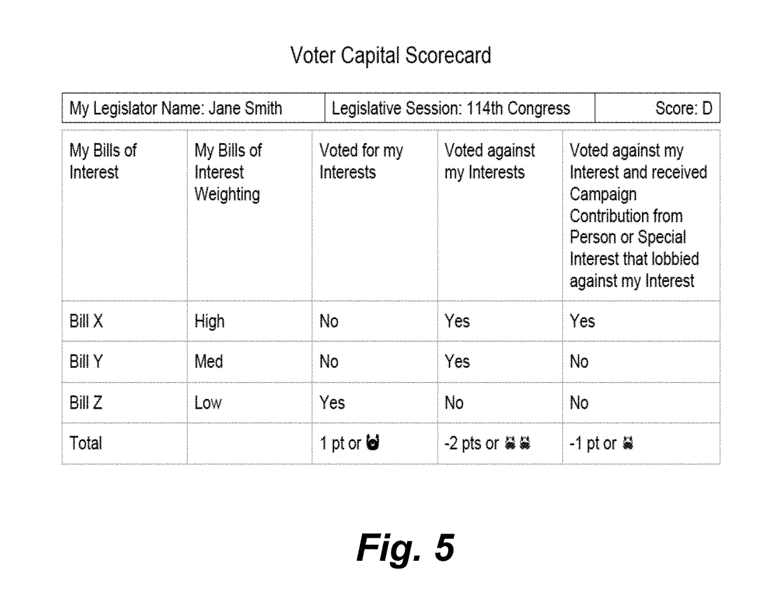

Referring to FIG. 3, shown is a confluence of actions that affect legislation by action on and with a legislator 210 to motivate him/her to act in response to one or more voters, where the actions are described as Influencing Tools 300. Combining voter actions is a powerful motivator. The influencing power of a Voter Movement 106 in a District Dᵢ may be expressed as P=(V*A)²; where V=number of Voters engaging their legislator in District Dᵢ (where i=1, . . . ,435, the number of legislative districts in the U.S. or equivalent zones in a state or local government) via the VILS 400 as further disclosed in FIG. 4; and where A≥1 is a weighted value of influencing modalities/actions used, and, the value of which is determined over time according to a legislator's behavioral responses. Examples of voter actions are: Crowd Funded Lobbying 302, Crowd Sourced Bills 304, Snap Votes 306 as further disclosed in FIG. 5, Campaign Contributions 308, Targeted Mailings and other Public Relations PR 310, and Other 312, such as funding issue research. Historical data on the legislator, his/her voting record, real-time legislative actions, and source of campaign funds are inputs which will enlighten voters as to the most effective stimulus for each legislator. These data will be part of the National Database 110 and District Aggregation Database 108 previously disclosed. And the databases will collect information on the various groups that are sponsoring and supporting legislation of interest both in opposition to the voters' interest and support.

Referring to FIG. 4, shown is the Voter Influence and Leveling System (“VILS) 400. The system 400 is implemented with the assistance of a computer network and is driven by Voters 104 who receive a Scorecard 402 via a software implemented user interface of a legislator's voting history on like legislation, campaign contributors, affiliated issue groups, etc. to detect voting patterns. Likewise, during a Voter Movement 106 legislative campaign, the Scorecard 402 is updated to reflect Voter Movement 106 impact on the legislators' behavior towards the target legislation. The Scorecard 402 sources its data from extrinsic and intrinsic sources, including data generated by the VILS 400. For instance, the Scorecard 402 accesses and updates data on legislators from the Legislators Database 404 and the Bills Database 406. Extrinsic sources include Library of Congress, other public databases and news sources, for example. The Legislators Database 404 also represents legislators' activities through all aspects of lawmaking. Likewise, the Bills Database 406 also represents the various forms and stages of bills, from introduction and amendments to death or approval, as the case may be.

Still referring to FIG. 4, Influencing Tools 300 are the combination of actions as previously disclosed in the discussion of FIG. 3 for Bills of interest. Combinations of these tools may be employed to motivate a legislator to vote in accordance with the Voter Movement's 106 wishes. The results from the tools' impacts on legislators are recorded in the Legislator Database 404. Looped into the network of databases and action elements is the Activist function 410. It may conduct legislative research, legislator education and represent the interest of the Voter Movements 106 to legislators and legislative bodies. The Voter Movements 106 fund it. The Activist 410 through Alert mechanism 412 alerts the Voter Movements on legislative activity of interest such as the introduction of bills, amendments, sponsors, hearings, markups, votes, etc. Said Alerts 412 can be real time and can be electronically disseminated via internet or cellular communications to PCs and mobile devices such as smart phones and tablets.

Still referring to FIG. 4, Bill Summarizing 414 provides the Voters 104 with legislation summaries and changes to bills via the user interface. Said Bill Summarizing 414 can include crowd sourced bill summaries, Library of Congress bill summaries, or otherwise sourced summaries.

Still referring to FIG. 4, shown are a plurality of example feedback loops. Accordingly, Voters 104 receives a plurality of sources of feedback via the user interface. For example, shown are: feedback from Bill Summarizing 414; feedback from Bills 406; feedback from Scorecard 402; and, feedback from Alerts 412. Each feedback loop provides Voters 104 with knowledge of Bills and Legislators' actions. Voters 104 can respond to such Bill knowledge and actions with further strategic influencing actions to further attempt to modify their Legislators' behavior. District Election Voting 408 represents the single most important action a voter can take. Based on a Legislator's behavior in response to Voter Movements 106, voters can decide how to cast their ballots in the District, Dᵢ, elections.

Referring to FIG. 5, shown is a Voter Capital Scorecard. The Scorecard is a user interface delivered via a computer network summarizing data about a legislator's actions, vis-à-vis, pending legislation or legislative issues, in relation to a user's influencing actions 300. It accesses data from V²2L platform 100 and Voter Influence and Leveling System 400. Shown is one format, for a particular voter, in which a legislator's voting records for such voter's Bills of Interest are listed as well as relevant campaign contributions. Presented is the data on My Bills of Interest Weighting from the Voter Influence and Leveling System 400 as a factor in scoring the legislator's decision making on the pending Bill. The Scorecard is tallied and emoji's or like figures can display the score. The same can be done for groups of legislators such as committee or caucus members, by region, party or other affiliations. And a Scorecard can be configured to show which lobbyist or interest group has spent money on an issue and to whom it has given.

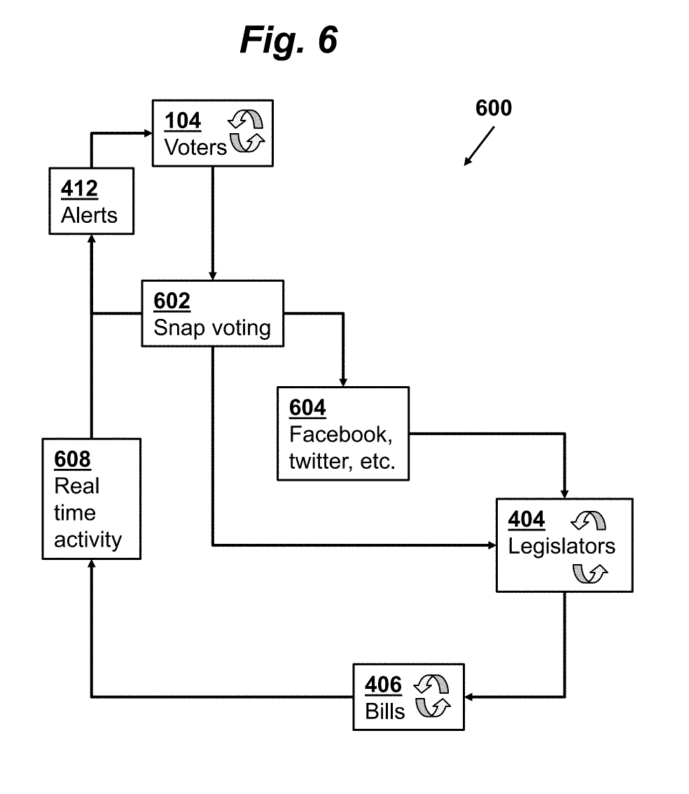

Referring to FIG. 6, shown is a voter-to-voter (V2V) Snap Voting System 600 implemented with the assistance of a computer network. Voters 104 create bills or topic specific Snap Votes 602 and convey this information via the user interface to legislators and others via Social Media 604 and the Legislators Activities Database 404. Voters within the V2V network learn via the user interface of created Snap Votes 602 via Alerts 412 and can vote or comment on such Snap Votes 602 thereby increasing their influencing power. The Social Media 604 feedback is transferred to and recorded in the Legislators Activities Database 404. The legislator response to accumulated snap voting data from this interaction is transferred via the computer network to and recorded in the Bills Database 606. Pertinent information generated by the Bills Database 606 is transferred to the Real Time Bill Activity Database 608 and on to Alerts 412 to alert the Voters 104 of significant activity.

Still referring to FIG. 6, shown is one feedback loop. Voters 104 receives feedback from Alerts 412 via the user interface. Such feedback loop provides Voters 104 with knowledge of Legislators' actions. Voters 104 can respond to such actions with further strategic influencing actions to further attempt to modify their Legislators' behavior.

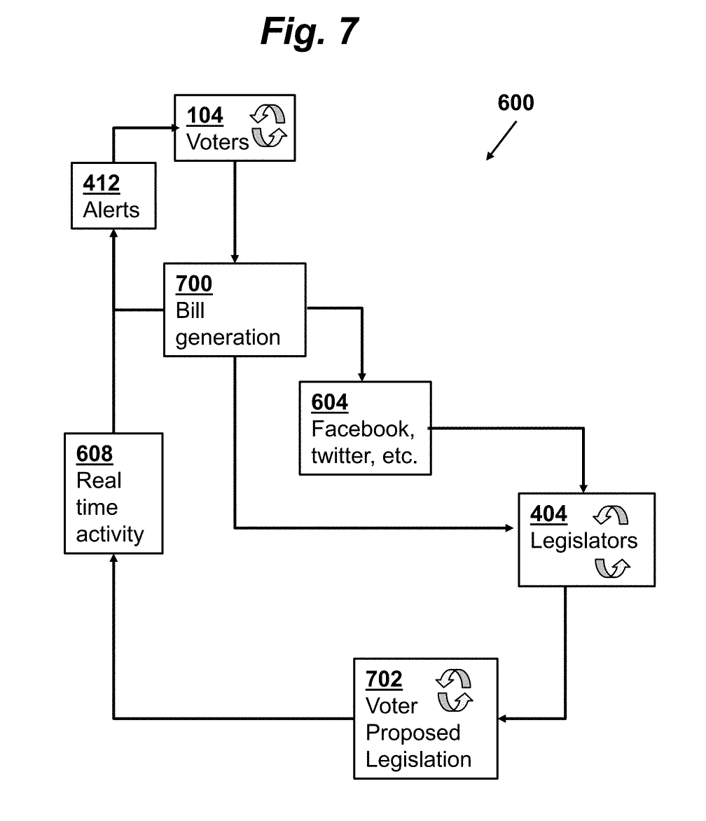

Referring to FIG. 7, shown is a V2V Legislation Generator 700 implemented with the assistance of a computer network. Voters 104 initiate legislation 700 via the user interface to drive legislation of interest via Alerts 412 to voters in their district proactively to generate a Voter Movement 106 for that legislation. The Voters 104 discuss and amend legislation via the user interface and then post it via Social Media 604 to attract support. The proposed legislation and the Social Media 604 support for it are transmitted via computer network to Legislators via the Legislators Activities Database 404. The legislation's progress is monitored in the Voter-Proposed Legislation Database 702 and reported to the Real Time Bill Activity Database 608 and to the Alerts function 412 to inform the Voters 104, via the user interface, of the legislation status.

Still referring to FIG. 7, shown is one feedback loop. Voters 104 receive feedback from Alerts 412 via the user interface. Such feedback loop provides Voters 104 with knowledge of Legislators' actions. Voters 104 can respond to such actions with further strategic influencing actions to further attempt to modify their Legislators' behavior.

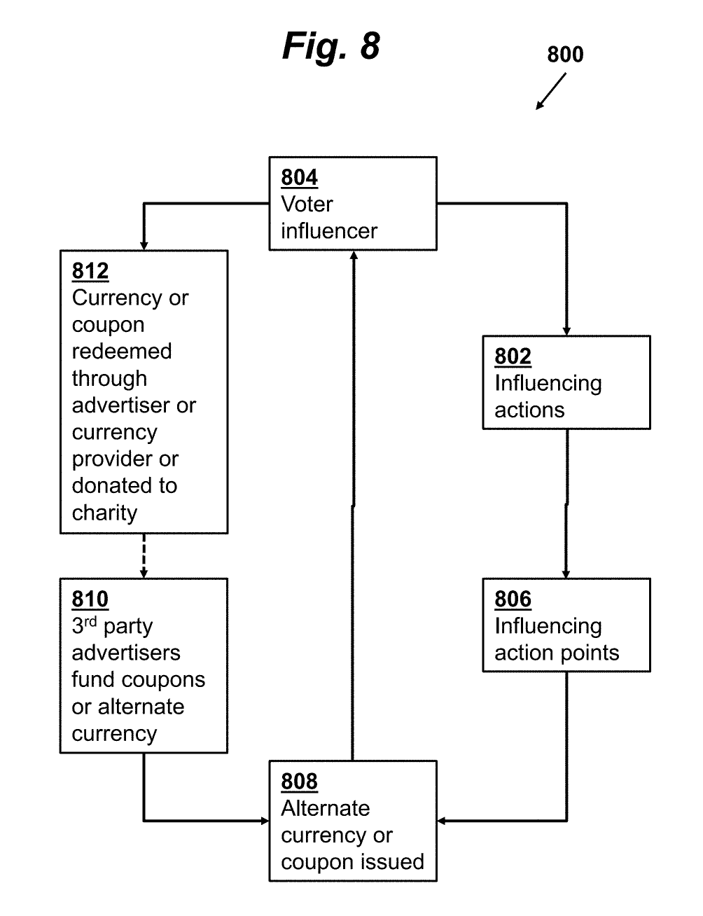

Referring to FIG. 8, shown is a Voter-Influencer Reinforcement System 800 implemented with the assistance of a computer network. Gaming has been shown to increase participation in certain activities. Here behavioral responses to gaming are invoked in order to provide rewarding stimuli from engagement in a Voter Influence and Leveling System 400. Influencing Actions 802 from use of Influencing Tools 300 provide a Voter 804 via the user interface with prescribed Influencing Action Points 806. Said Influencing Action Points 806 may be recorded in a block chain format or open ledger and are converted via a software program into Alternate Currency or Coupons 808 through payments made over a computer network by third party advertisers 810. Voter-Influencer 804 decides, via the user interface, if they wish to donate said Alternate Currency or Coupons to charity, via the operator of the Voter-Influencer Reinforcement System 800 or whether they wish to redeem them through a corporate advertiser or alternative currency provider.

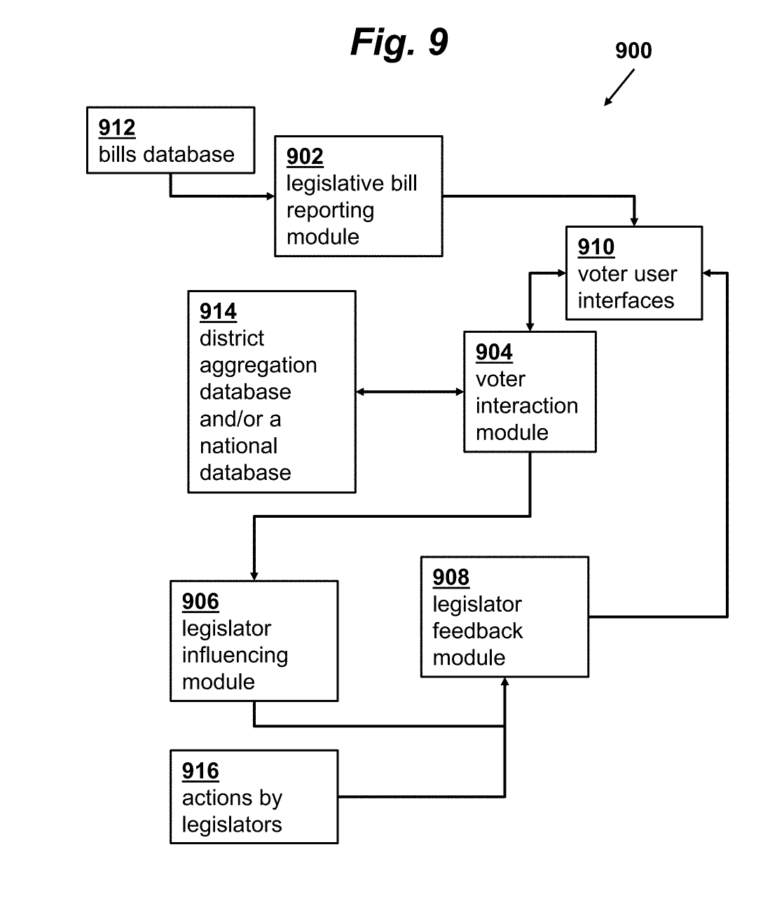

FIG. 9 is a block diagram of a voter-driven system 900 for supporting deliberative democracy implemented on a computer network. The system includes a legislative bill reporting module 902 configured to report legislative bills to voters via user interfaces 910 from a bills database 912. It includes a voter interaction module 904 configured to allow interaction via user interfaces 910 among voters to share and find common interests, to create voter movements, including legislative movements, of voters having common interests, to disseminate voter movements and/or influencing action information to the voters, and to aggregate the voter movements and/or influencing actions around political issues in a district aggregation database and/or a national database 914. The system 900 includes a legislator influencing module 906 configured to communicate to legislators information about voter movements and/or influencing actions using influencing tools, where voter movements may be assigned weighting power based on the number of voters in the movements and the influencing modalities used. The system includes a legislator feedback module 908 configured to provide the voters and/or voter movements with information via a user interface of actions by legislators 916 and the effect of the voter influencing tools on the actions. The modules, databases, and interfaces of the system may be implemented on multiple computing devices connected via a digital communication network.

1. A voter-driven system for supporting deliberative democracy, the system comprising:
a legislative bill reporting module configured to report legislative bills to voters via a user interface from a bills database;
a voter interaction module configured to allow interaction via a user interface among the voters to share and find common interests, to create voter movements of voters having common interests, to disseminate voter movements and/or influencing action information to the voters, and to aggregate the voter movements and/or influencing actions around political issues in a district aggregation database and/or a national database;
a legislator influencing module configured to communicate to legislators information about voter movements and/or influencing actions using influencing tools, where voter movements are assigned weighting power based on the number of voters in the movements and the influencing modalities used;
a legislator feedback module configured to provide the voters and/or voter movements with information via a user interface of actions by legislators and the effect of the voter influencing tools on the actions.

2. The voter-driven system of claim 1 further comprising the influencing tools including a snap voting system for collecting snap votes from the voters and to convey snap vote results to legislators.

3. The voter-driven system of claim 1 further comprising a reward module configured to provide the voters with rewards for voter participation in voter movements and/or influencing actions.

4. The voter-driven system of claim 1 further comprising the legislator feedback module configured to provide a scorecard displaying tabulated scores reflecting a legislator's voting record, retrieved from a legislator database and from a bills database in relation to a voter's interests.

5. The voter-driven system of claim 1 further comprising the legislator influencing module configured to communicate with an activist representing the interest of a voter movement.

6. The voter-driven system of claim 1 further comprising the legislator influencing module configured to facilitate decisions in district election voting for a district and communicate the results to legislators representing the district.

7. A voter-driven method for supporting deliberative democracy comprising, presenting a legislative initiative to voters using an electronic communications network;
creating a voter movement on the legislative initiative;
conducting a snap-vote among voters belonging to the voter movement;
dynamically scoring the snap-vote using logic in a computing device;
communicating the result to a legislator; and
alerting the voters belonging to the voter movement of a legislator response to a snap-vote.

8. The method of claim 7 further comprising updating a user interface with snap-vote results.

9. The method of claim 7 further comprising assigning a score to a scorecard based on a reaction of the legislator to snap-votes and graphically displaying the scorecard.

10. A voter-to-voter legislation generator method comprising:
initiating a legislative initiative by one or more voters;
modifying the legislative initiative by the voters over a communication system;
communicating the modified legislative initiative to legislators;
monitoring responses by the legislators to the modified legislative initiative; and
alerting the voters of activity on the modified legislative initiative.

11. The method of claim 10 further comprising displaying the responses by the legislators to the modified legislative initiative.

12. A method for rewarding voter participation comprising:
creating action points;
awarding action points to a voter for participation in a movement;
converting the action points into an alternative currency or coupon; and
recording the converted action points in an electronic format in a computing storage device.

13. The method of claim 12 further comprising redeeming the alternative currency or coupon.

14. The method of claim 12 further comprising recording action points in a block chain format.

15. The method of claim 12 further comprising recording action points in an open ledger.
